(19) United States
(12) Patent Application Publication
(10) Pub. No.: US 2003/0121187 A1
(43) Pub. Date: Jul. 3, 2003

(54) Rollout greeting card

(76) Inventor: Michael Stephen Ryan, Kalispell, MT (US)

Correspondence Address: MICHAEL S. RYAN, 335 COMMONS WAY, KALISPELL, MT, 59901, US

(21) Appl. No.: 10/040,849

(22) Filed: Dec. 29, 2001

(51) Int. Cl. G09F 1/00

(52) U.S. Cl. 40/124.01; 40/514

(57) ABSTRACT

A Rollout Greeting Card comprises a flat body of pliable, coiled material whereon artwork and wording can be inscribed which when uncoiled gradually reveals the artwork and wording thereon.

### CROSS REFERENCE TO RELATED APPLICATIONS

Not Applicable

### BACKGROUND—FIELD OF INVENTION

This invention relates to greeting cards for all occasions.

### BACKGROUND—DESCRIPTION OF PRIOR ART

The greeting card industry is one of the largest in the world. Such cards commemorate occasions from birthdays to graduations to divorce to obscure holidays and religious events. There are countless minor variations to the embodiment of the greeting card, too many to detail individually. However they are all manifested in five common types:

1—Single-fold opening

2—Multiple-fold “accordion” opening

3—Pop-up

4—Flap Windows

5—Musical

Each of these embodiments represents a different way to deliver the message. The single-fold opening type contains an illustration and/or introductory wording on the cover and when opened reveals the concluding illustration and/or wording on the inside. The multiple-fold “accordion” opening type follows the same pattern but allows a more elaborate message through multiple illustration and wording stages. The pop-up type card can be single or multiple opening and is set apart by the artwork rising from the body of the card when opened. The flap-window type is also single or multiple opening but contains varying numbers of flaps within the card that are opened to reveal specific artwork or wordings. The musical type card can be any of the four types but with the addition of a small built-in device that provides musical accompaniment to the message.

All of these greeting card types allow for a wide range of creativity when delivering the message. However, they all contain limitations:

the single fold opening type allows only a simple message which must be communicated within two panels.

the multiple-fold “accordion” opening type permits a more elaborate message and illustration sequence but the artwork is interrupted by the folds and the entire card, including the conclusion, is revealed immediately when opened limiting the opportunity to create suspense or surprise.

the pop-up type provides an exciting three-dimensional effect but it is either held to one opening or it becomes bulky and difficult to handle.

the flap-window type creates surprise through the elements hidden under the flaps but is unable to produce incremental or continuous message development.

the musical accompaniment of the musical type card is a unique element but otherwise these cards follow one of the other four embodiments and share their artwork and message limitations.

### SUMMARY

In accordance with the present invention, a Rollout Greeting Card comprises a flexible, rolled-up material that accepts print and illustrations which when extended gradually reveals the artwork and wording inside, keeping the conclusion hidden until the end.

### OBJECTS AND ADVANTAGES

Accordingly, besides the advantages of the greeting cards it allows an unlimited approach to the artwork described in my above patent, several objects and advantages of the present invention are:

a) it allows a unique approach to the artwork through either panels, continuous development, panorama or any combination of each

b) opening or “rolling-out” of the card incrementally reveals the artwork and/or wording, allowing a unique approach to message development

c) the rollout format allows suspense and/or surprise by preventing premature revealing of the conclusion or punch line.

### DRAWING FIGURES

All figures denoted by a single numeral. The present invention is of a simplicity that precludes the necessity of reference numerals or alphabetic suffixes.

FIG. 1—shows the Rollout greeting card in its unopened or coiled position.

FIG. 2—shows the Rollout greeting card in its fully opened or uncoiled position.

FIG. 3—shows an additional embodiment of the present invention, in its unopened or coiled position, where the top-to-bottom dimensions increase as the card is opened or uncoiled.

FIG. 4—shows the embodiment of FIG. 3 in its fully opened or uncoiled position.

FIG. 5—shows an additional embodiment of the present invention, in its unopened or coiled position, where the top-to-bottom dimensions decrease as the card is opened or uncoiled.

FIG. 6—shows the embodiment of FIG. 5 in its filly opened or uncoiled position.

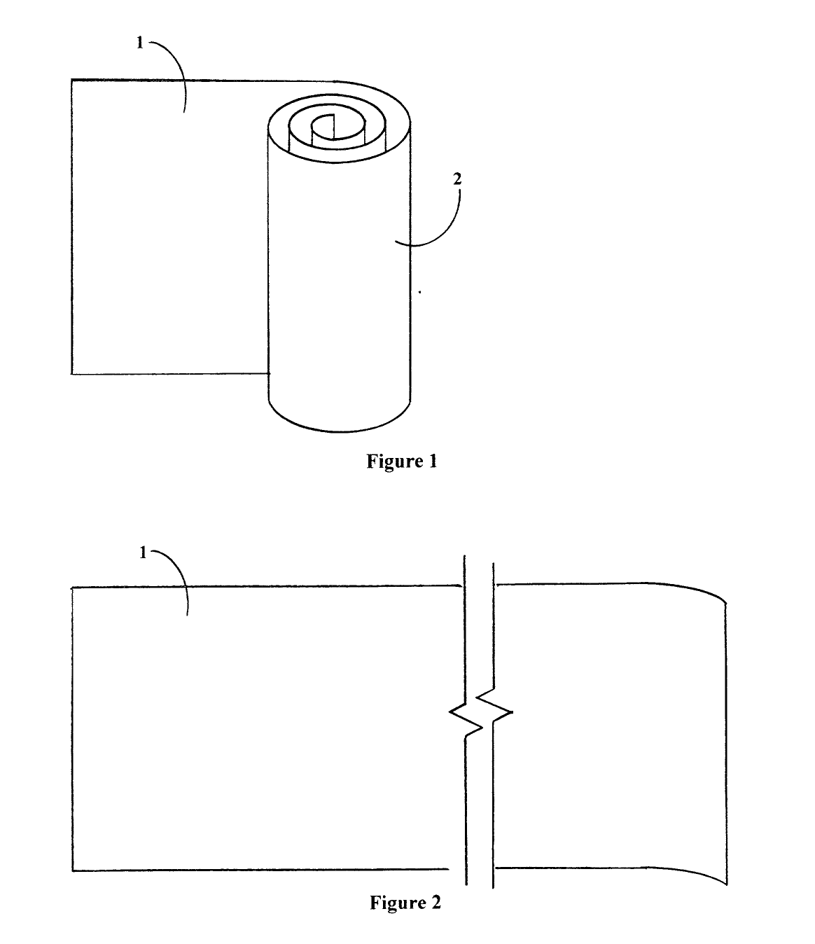

### DESCRIPTION—FIGS. 1 and 2—PREFERRED EMBODIMENT

The preferred embodiment of the present invention is illustrated in FIGS. 1 and 2. The Rollout greeting card is made of a flexible sheet of material that accepts artwork and wording and which can be rolled out and in, (uncoiled and recoiled), repeatedly. FIG. 1 shows the disposition of the present invention when obtained by the recipient and prior to opening. The face of the card (1) contains the artwork and/or wording with business and legal information printed on the back (2). The quantity of exposed flat portion can be varied as desired. The vertical dimension (height) and horizontal dimension (length) are independent of each other and vary as desired for each application. The recipient rolls the material from left to right, slowly revealing the artwork and/or wording. The rolling out continues until the end is reached (FIG. 2). At this point the entire message is visible.

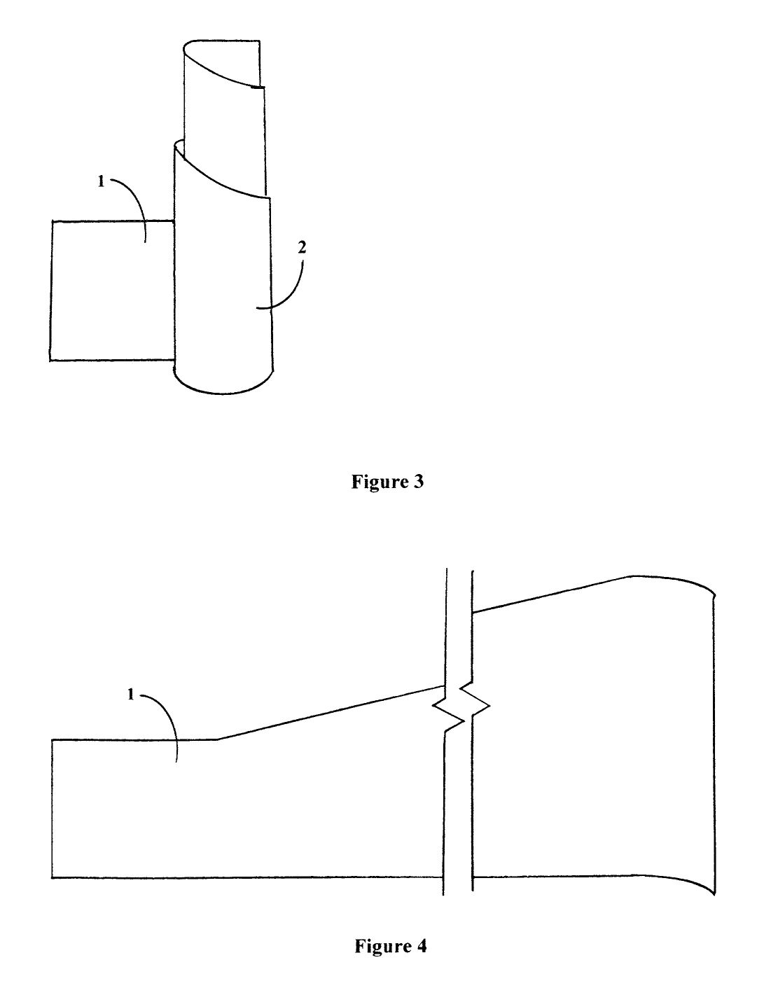

FIGS. 3-6—Additional Embodiments

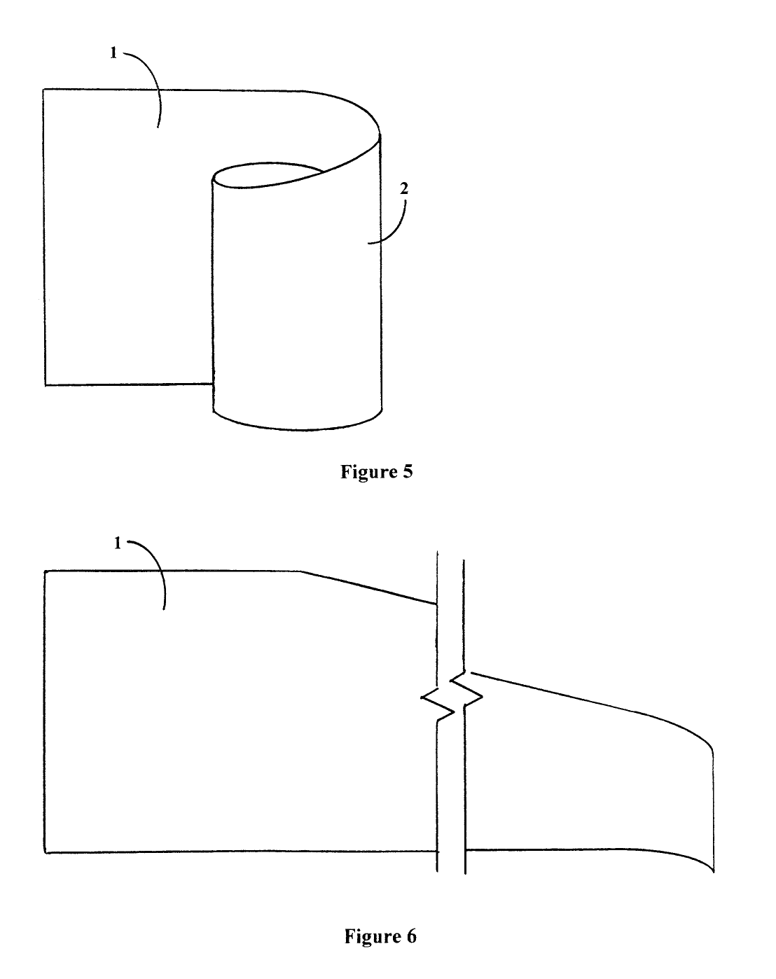

Additional embodiments are shown in FIGS. 3, 4, 5, and 6. In FIGS. 3 and 4, the vertical dimensions (height) of the present invention increase as the card is uncoiled or rolled out. In FIGS. 5 and 6, the height of the present invention decrease as the card is uncoiled or rolled out.

Advantages

From the description above, a number of advantages of the present invention become evident:

a) the long, continuous panel allows a great deal of flexibility to be applied to the artwork and wording

b) unlimited variation in the length and height of the card give the artist tremendous flexibility in delivering the message

c) incremental uncoiling or rolling out of the card provides another unique approach to message development

d) the rollout format allows the creation of suspense and/or surprise by preventing premature revealing of the conclusion or punch line

Operation

The operation of the Rollout Greeting Card is very simple. The card is received in the coiled position (FIGS. 1, 3, 5). The flat end is held between the fingers of one hand. The coiled portion is grasped with the other hand and uncoiled (rolled out) until the end is reached (FIGS. 2, 4, 6).

Conclusion, Ramifications and Scope

Accordingly, the reader will see that the Rollout Greeting Card provides a unique method of delivering a message or greeting:

The single, variable length and height panel gives the artist a canvas of virtually endless variation upon which to develop a message.

The continuous, incremental revealing of the artwork and/or wording allows a gradual approach to the message unavailable in existing greeting card types.

The rollout format allows the creation of suspense and/or surprise by keeping the conclusion of the message concealed until the very end.

Although the description above contains many specificities, these should not be construed as limiting the scope of the invention but only as providing examples of some of the presently preferred embodiments of this invention. For example, there can be variation in the vertical dimensions within the card, increasing and decreasing, as it is uncoiled. The card could also be uncoiled or rolled out from right to left, to accommodate Hebrew or Arabic scripts, or from top to bottom as a variation in any application.

Thus, the scope of the invention should be determined by the appended claims and their legal equivalents, rather than by the examples given.

I claim:

1. A greeting card of the type comprising:
a) a flat body of pliable, printable material of sufficient size and length to accommodate artwork and wording thereon
b) said flat body is coiled thereby initially concealing the artwork and wording contained thereon

2. The greeting card of claim 1 wherein the coiled flat body is uncoiled incrementally from left to right therein revealing the artwork and wording thereon

3. The greeting card of claim 1 wherein the height of said greeting card increases as said greeting card is uncoiled

4. The greeting card of claim 1 wherein the height of said greeting card decreases as said greeting card is uncoiled

5. The greeting card of claim 1 wherein the coiled flat body is uncoiled incrementally from right to left therein revealing the artwork and wording thereon
